(19) United States
(12) Patent Application Publication
(10) Pub. No.: US 2013/0307800 A1
(43) Pub. Date: Nov. 21, 2013

(54) TOUCH DISPLAY PANEL

(71) Applicants: Chih-Chiang Cheng, Yunlin County (TW); Po-Hsien Wang, Taichung City (TW); Chen-Hao Su, Taichung City (TW)

(72) Inventors: Chih-Chiang Cheng, Yunlin County (TW); Po-Hsien Wang, Taichung City (TW); Chen-Hao Su, Taichung City (TW)

(73) Assignee: WINTEK CORPORATION, Taichung City (TW)

(21) Appl. No.: 13/895,383

(22) Filed: May 16, 2013

(30) Foreign Application Priority Data
May 17, 2012 (TW) 101117607

(51) Int. Cl. G06F 3/041

(52) U.S. Cl. CPC G06F 3/0412
USPC 345/173

(57) ABSTRACT

A touch display panel includes a first substrate, a second substrate, a plurality of scan lines and data lines, a plurality of active devices, and an organic light emitting diode pixel array is provided. The first substrate is opposite to the first substrate. The scan lines and the data lines are intersected and disposed on the first substrate. The active devices are disposed on the first substrate, and each active device is electrically connected with the corresponding scan line and data line. The organic light emitting diode pixel array includes a plurality of organic light emitting diode pixel units, and is disposed on the first substrate. Each organic light emitting diode pixel unit includes a first electrode, a second electrode and an organic light emitting layer. At least one of the scan lines, data lines and the second electrodes transmits a touch driving signal or a touch sensing signal.

### CROSS-REFERENCE TO RELATED APPLICATION

This application claims the priority benefit of Taiwan application serial no. 101117607, filed on May 17, 2012. The entirety of the above-mentioned patent application is hereby incorporated by reference herein and made a part of this specification.

### BACKGROUND

1. Field of the Invention

The invention relates to a display device, and more particularly, to touch display panel.

2. Description of Related Art

Following the vigorous development of electronic technology, and the popularisation of wireless communications and networks, various electronic devices gradually become indispensable tools in people's daily life. However, a commonly used input/output (I/O) interface such as a keyboard or a mouse has a certain degree of operational difficulty. Comparatively, a touch panel is an intuitive and simple I/O interface. Therefore, the touch panel is commonly applied as a communication interface between a man and an electronic device to perform control.

Current development trends of the electronic products are continuously forwarding towards a technology of integrating the touch panel into a display panel to constitute a touch display panel. The conventional touch display panel is to attach the touch panel onto the display panel after separately manufactured the touch panel and the display panel. The touch display panel produced with the aforementioned method has several shortcomings of high cost, thick thickness, heavy weight, and low transmittance, and thus still has rooms for further improvement.

### SUMMARY OF THE INVENTION

The invention provides a touch display panel, which is integrated with a display function and a touch sensing function in a same component, capable of omitting a conventional touch panel to achieve a panel thinning effect.

The invention provides a touch display panel with a display screen. The touch display panel includes a first substrate, a plurality of scan lines, a plurality of data lines, a plurality of active devices, and an organic light emitting diode pixel array. The scan lines and the data lines are disposed on the first substrate, wherein the scan lines and the data lines are intersected. The active devices are disposed on the first substrate, wherein each active device is electrically connected with one of the corresponding scan lines and one of the corresponding data lines. The organic light emitting diode pixel array is disposed on the first substrate, wherein the organic light emitting diode pixel array includes a plurality of organic light emitting diode pixel units, and each organic light emitting diode pixel unit includes a first electrode, a second electrode and an organic light emitting layer. The first electrode is disposed on the first substrate and electrically connected with the corresponding active device. The second electrode is disposed on the first substrate. The organic light emitting layer is disposed on the first substrate, and the organic light emitting layer is disposed between the first electrode and the second electrode. Wherein, at least one of the plurality of scan lines, the plurality of the data lines and the plurality of the second electrodes transmits a touch driving signal or a touch sensing signal.

According to the foregoing, the invention directly utilizes at least one of the plurality of scan lines, the plurality of data lines and the plurality of second electrodes in the organic light emitting diode pixel array to transmit the touch driving signal or the touch sensing signal. Whereby, the touch sensing function may be directly integrated into a component of a display panel, and therefore, a processing number and a photomask number of the touch display panel may be reduced, so as to simplify the manufacturing process and reduce the cost of touch display panel, while realizing a thinning touch display panel, which is integrated with a touch function and a display function.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a touch display panel according to a first embodiment.

FIG. 1B is a schematic top view of the touch display panel according to the first embodiment.

FIG. 1C is another schematic top view of a touch display panel according to the first embodiment.

FIG. 1D is a schematic view illustrating a group of scan lines of the touch display panel according to the first embodiment.

FIG. 1E is a schematic view illustrating a group of data lines of the touch display panel according to the first embodiment.

FIG. 2A is a schematic cross-sectional view of a touch display panel according to a second embodiment.

FIG. 2B is a schematic top view of the touch display panel according to the second embodiment.

FIG. 2C is another schematic top view of the touch display panel according to the second embodiment.

FIG. 2D is a schematic cross-sectional view of an alternative touch display panel according to the second embodiment.

FIG. 3A is a schematic cross-sectional view of a touch display panel according to a third embodiment.

FIG. 3B is a schematic top view of the touch display panel according to the third embodiment.

FIG. 3C is another schematic top view of the touch display panel according to the third embodiment.

FIG. 4A is a schematic cross-sectional view of a touch display panel according to a fourth embodiment.

FIG. 4B is a schematic top view of the touch display panel according to the fourth embodiment.

FIG. 4C is a schematic cross-sectional view of an alternative touch display panel according to the fourth embodiment.

### DETAILED DESCRIPTION OF DISCLOSED EMBODIMENTS

### First Embodiment

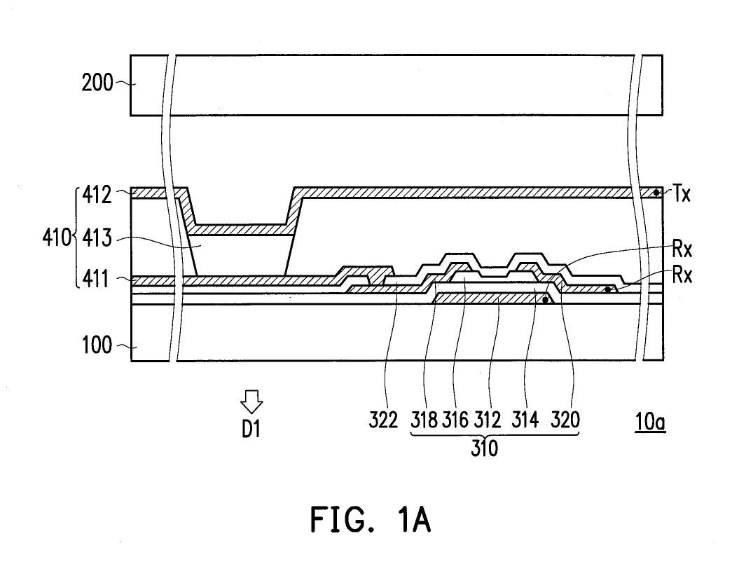

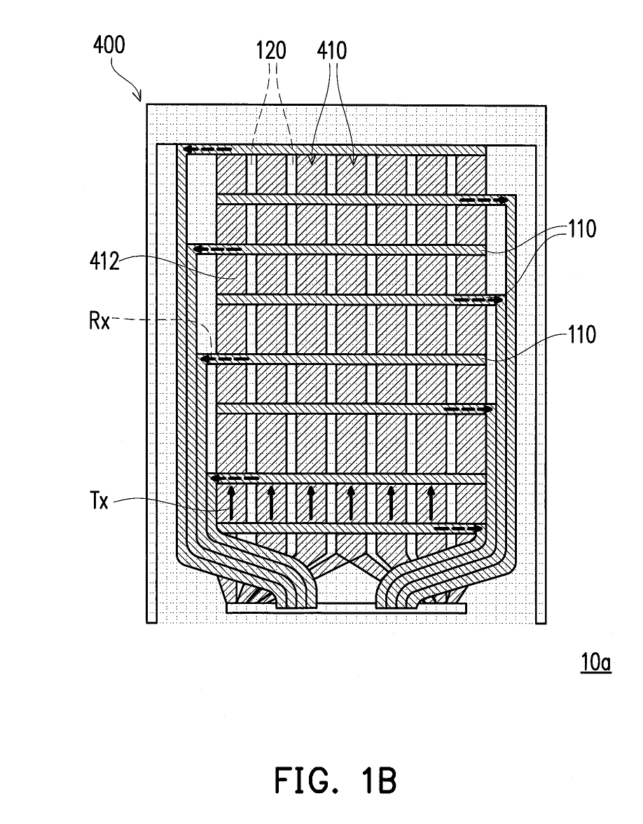

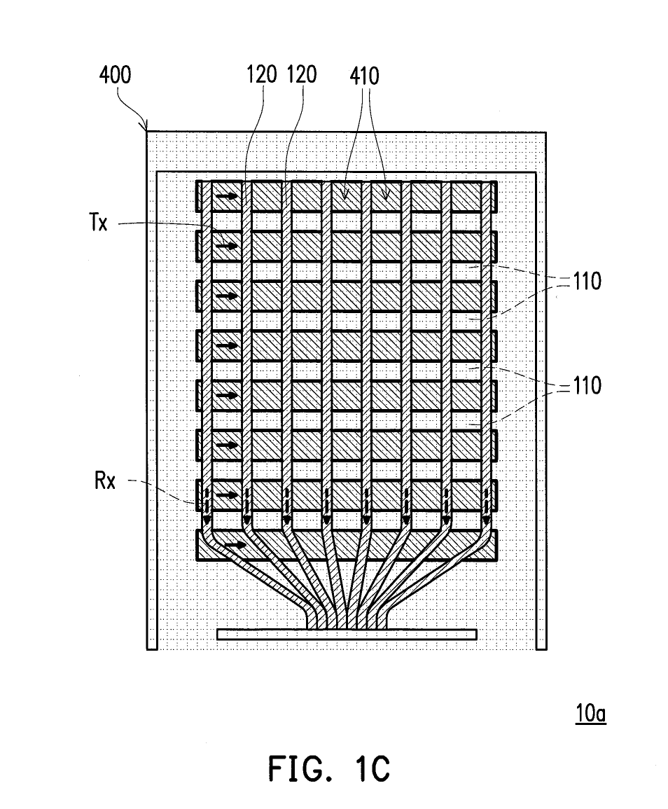

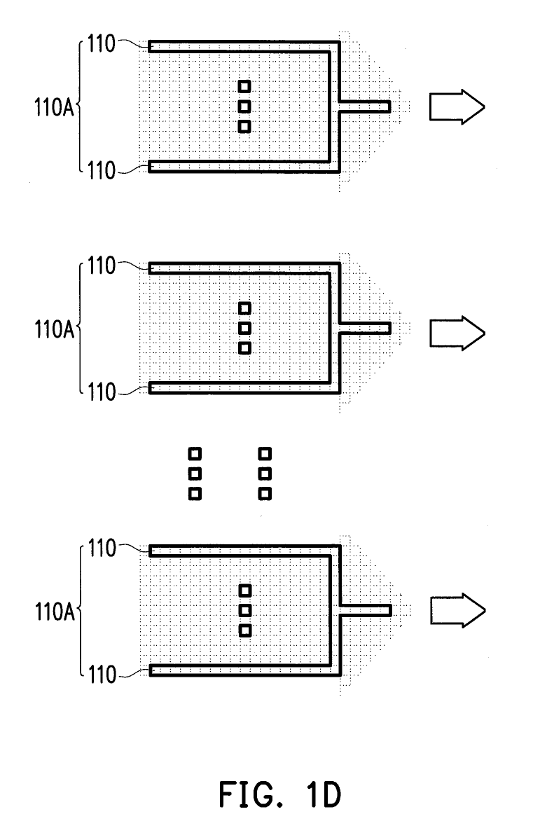

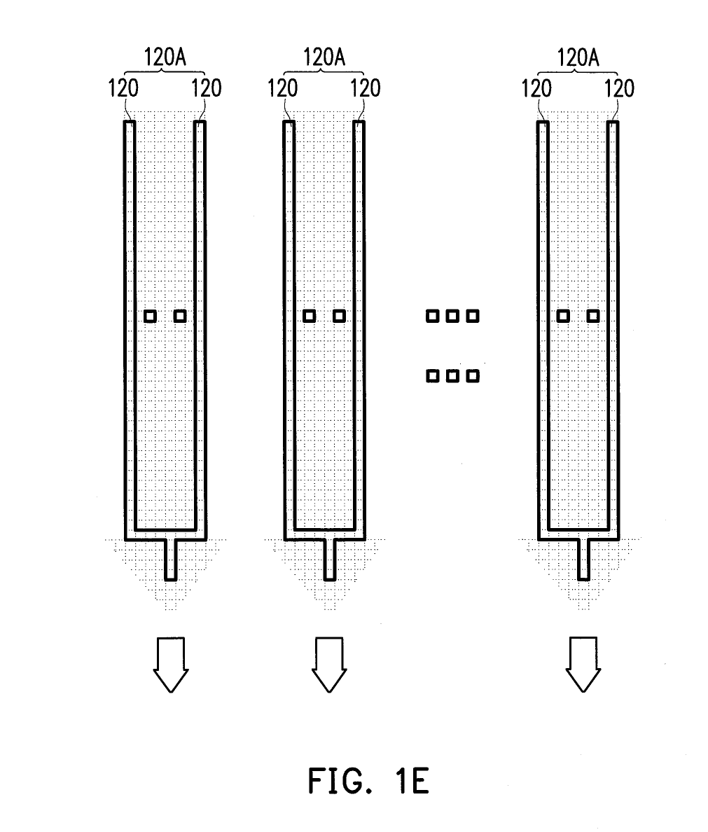

FIG. 1A is a schematic cross-sectional view of a touch display panel according to a first embodiment, and FIG. 1B and FIG. 1C are two schematic top views of the touch display panel mainly show the signal path for transmitting the touch sensing signal according to the first embodiment. Referring to FIG. 1A, FIG. 1B and FIG. 1C, the touch display panel 10a of the present embodiment includes a first substrate 100, a second substrate 200, a plurality of scan lines 110, a plurality of data lines 120, a plurality of active devices 310, and an organic light emitting diode pixel array 400. The first substrate 100 is opposite to the second substrate 200. The scan lines 110 and the data lines 120 are intersected on the first substrate 100 to define a plurality of organic light emitting diode pixel units 410, wherein the touch display panel showing in FIG. 1B also has data lines 120 at the same positions as the touch display panel showing in FIG. 1C, and the touch display panel showing in FIG. 1C also has scan lines 110 at the same positions as the touch display panel showing in FIG. 1B. The active devices 310 are disposed on the first substrate 100, wherein each active device 310 is electrically connected with one of the corresponding scan lines 110 and one of the corresponding data lines 120. The active devices 310 is disposed within one of the organic light emitting diode pixel units 410 disposed at an intersection of scan lines 110 and data lines 120 shown in FIG. 1B or FIG. 1C. The organic light emitting diode pixel array 400 is disposed on the first substrate 100. The touch display panel 10a of the present embodiment utilizes the first substrate 100 as a display screen to display an organic emitted light towards a direction D1; therefore, the touch display panel 10a belongs to a bottom-emission structure. Noteworthily, the touch display panel 10a is able to integrate a touch driving signal Tx and a touch sensing signal Rx within a touch signal into a component and a trace, which transmit a display signal.

In detail, as shown in FIG. 1A, FIG. 1B and FIG. 1C, the organic light emitting diode pixel array 400 includes a plurality of organic light emitting diode pixel units 410 in an array arrangement, and each organic light emitting diode pixel unit 410 includes a first electrode 411, a second electrode 412 and an organic light emitting layer 413. The first electrode 411 is disposed on the first substrate 100 and electrically connected with the corresponding active device 310. The second electrode 412 is disposed on the first substrate 100. The organic light emitting layer 413 is disposed on the first substrate 100, and the organic light emitting layer 413 is disposed between the first electrode 411 and the second electrode 412. Particularly, in the touch display panel 10a of the present embodiment, the scan lines 110 or the data lines 120 may be directly utilized for transmitting the touch sensing signal Rx; for example, FIG. 1B shows that the scan lines 110 are utilized for transmitting the touch sensing signal Rx, while FIG. 1C shows that the data lines 120 are utilized for transmitting the touch sensing signal Rx, and the second electrodes 412 are utilized for transmitting the touch driving signal Tx.

A material of the first substrate 100 and the second substrate 200 may be a glass, a quartz, an organic polymer, or a flexible material, to enhance a mechanical strength of the touch display panel 10a and to provide a good light transmittance. A light emitting structure of organic light emitting diode pixel of the present embodiment is the bottom-emission structure, and the first substrate 100 is utilized as the display screen and a touch screen. Moreover, a plurality of signal lines (the scan lines or the data lines) close to the first substrate 100 transmits the touch sensing signal Rx in a specific timing, and the second electrodes away from the first substrate 100 transmits the touch driving signal Tx in a specific timing. Hence, a display component and a touch sensing component may be integrated by using only two substrates (100 and 200). Therefore, the touch display panel 10a, under a condition of not significantly increasing a thickness thereof, can have both a touch sensing function and a display function.

Specifically, the active devices 310 are electrically connected with the first electrodes 411 to enable the organic light emitting diode pixel array 400 to perform an active drive. As shown in FIG. 1A, each active device 310 is, for example, a thin film transistor or other switch element with three terminals, which is mainly constituted of a gate electrode 312, an insulating layer 314, a channel layer 316, a source electrode 318, and a drain electrode 320. The gate electrode is 312 is disposed on the first substrate 100 and electrically connected with the scan line 110 shown in FIG. 1B, the insulating layer 314 is covering the gate electrode 312, the channel layer 316 is disposed on the insulating layer 314 above the gate electrode 312, and the source electrode 318 and the drain electrode 320 are disposed at the two sides of the channel layer 316. The drain electrode 320 is electrically connected with the data line 120 shown in FIG. 1C. In addition, a protective layer 322 may be covered on the source electrode 318 and the drain electrode 320 of the active device 310. Each organic light emitting diode pixel unit 410 is able to present a desired degree of brightness and darkness to constitute a desired display image through a control of corresponding active device 310.

In more detail, the first electrode 411 and the second electrode 412 of each organic light emitting diode pixel unit 410 may respectively be a cathode and an anode, or an anode and a cathode, of the organic light emitting diode pixel unit 410. The first electrode 411 and the second electrode 412 may intertwine each other in a strip form, or may form some graphics such as a reticular structure and so on. Between the first electrode 411 and the second electrode 412 is the organic light emitting layer 413, which, in addition of producing light emitting property through an integration of an electron and an electronic hole, may further include an electron transfer layer and an electronic hole transfer layer according to the demand for enduing features of electronic hole transfer and electron transfer.

The following explains the embodiment of transmitting the touch sensing signal Rx by one of the scan lines 110 and the data lines 120 in the touch display panel 10a, and transmitting the touch driving signal Tx by utilizing the second electrodes 412 of the organic light emitting diode pixel array 400.

More specifically, since the organic light emission has a relaxation process, the organic light emitting diode pixel units 410 are not able to display signal during the relaxation process. Hence, by utilizing the time during the relaxation process of the organic light emitting diode pixel units 410, the touch sensing signal Rx may be transmitted in the specific timing through the signal lines (the scan lines 110 or the data lines 120) close to the first substrate 100, and the touch driving signal Tx may be transmitted in the specific timing through the second electrodes 412 away from the first substrate 100. In other words, the scan lines 110 respectively transmit a scanning signal and the touch sensing signal Rx with different timings (the data lines 120 respectively transmit a data signal and the touch sensing signal Rx with different timings), and the second electrodes 412 respectively transmit a common signal and the touch driving signal Tx with different timings.

For example, during the relaxation process of the organic light emitting diode pixel units 410, the organic light emitting diode pixel units 410 are not able to transmit the display signal; while at this time, the scan lines 110 may be utilized as the signal lines to transmit the touch sensing signal Rx. On the other hand, when the scan lines 110 are in a timing of scanning enable level, the scan lines 110 are then not able to be utilized as the signal lines to transmit the touch sensing signal Rx. Therefore, two neighbouring frame times within the period of the relaxation process of the organic light emitting diode pixel units 410 may be utilized for transmitting the touch sensing signal Rx. As a result, the scan lines 110 are able to respectively transmit the scanning signal and the touch sensing signal Rx with different timings, and thus achieve an effect of sharing lines between the display signal and the touch signal.

Similarly, when the data lines 120 are utilized as the signal lines to transmit the touch sensing signal Rx, because the organic light emitting diode pixel units 410 is not able to transmit the display signal during the relaxation process of the organic light emitting diode pixel units 410, the data lines 120 may be utilized as the signal lines to transmit the touch sensing signal Rx. Certainly, when the data lines 120 are in a timing of scanning enable level, the data lines 120 are not able to be utilized as the signal lines to transmit the touch sensing signal Rx. Therefore, the two neighbouring timings within the period of the relaxation process of the organic light emitting diode pixel units 410 may be utilized for transmitting the touch sensing signal Rx. As a result, the data lines 120 are able to respectively transmit the data signal and the touch sensing signal Rx with different timings, and thus also achieve the effect of sharing lines between the display signal and the touch signal.

In addition, in order to transmit different signal transmissions with different timings on a same trace, a signal switcher (not shown) may be disposed at a signal input terminal of the trace to switch an electrically connected display signal or an electrically connected touch signal of the trace. For example, when the scan lines 110 are utilized as the signal lines to transmit the touch sensing signal Rx, the signal switcher is disposed at a signal input terminal of the scanning signal and the touch sensing signal to switch to transmit the scanning signal or transmit the touch sensing signal Rx in different timings. Similarly, the same concept may be applied to the data lines 120 or the second electrodes 412 to transmit different signals at different timings, thus designing a functionality of achieving both display and touch with the same trace.

In addition, in order to enhance a sensing function of the touch sensing signal Rx of the touch display panel 10a, a pattern design of the scan lines 110 and the data lines 120 in the organic light emitting diode pixel array 400 may be as shown in FIGS. 1D and 1E. In practice, each scan line 110 may be utilized for transmitting the touch sensing signal Rx, and in addition, a plurality of scan lines 110 may be combined into a scan line group 110A, such that the scan lines 110 in each scan line group 110A in the timing of transmitting the touch signal are simultaneously transmitting the touch sensing signal Rx, and the scan lines 110 in the same scan line group 110A in the timing of transmitting the display signal are electrically separated from each other by another signal switcher, so as to enable each scan line 110 to respectively transmit the respective scanning signal. Similarly, as shown in FIG. 1E, a plurality of data lines 120 may be combined into a data line group 120A to simultaneously transmit the touch sensing signal Rx in the timing of transmitting the touch signal, and the data lines 120 in the same data line group 120A in the timing of the display signal are electrically separated from each other by another signal switcher, so as to enable each data line 120 to respectively transmit the respective data signal. The pattern design of the scan lines 110 and the data lines 120 is able to enhance a sensor capacitance and a signal-to-noise ratio (SNR), and is contributive in enhancing an overall induction capacity.

The following uses different embodiments to describe the designs of a plurality of touch display panels 10b-10f. It is noted that the following embodiments adopt the element symbols and part of the contents of the previous embodiment, wherein same element symbols are employed to present the same or similar elements, and descriptions of same technical contents are omitted. The omitted part of the descriptions may be referred to the previous embodiment, and thus are not repeated in the following embodiments below.

### Second Embodiment

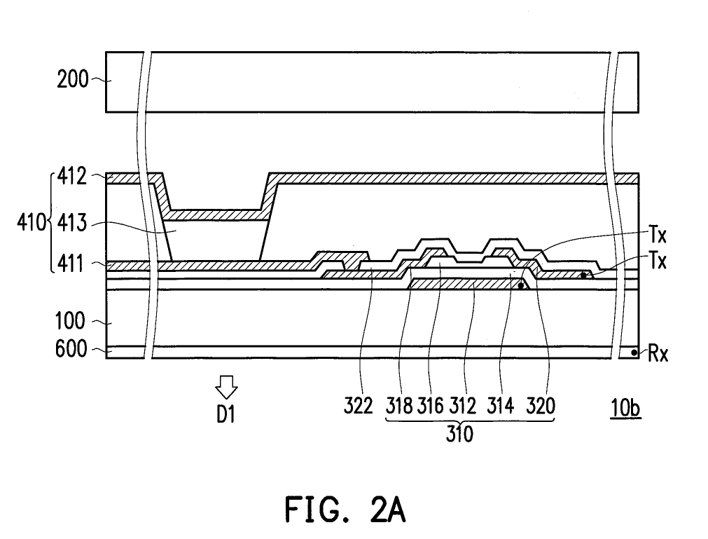

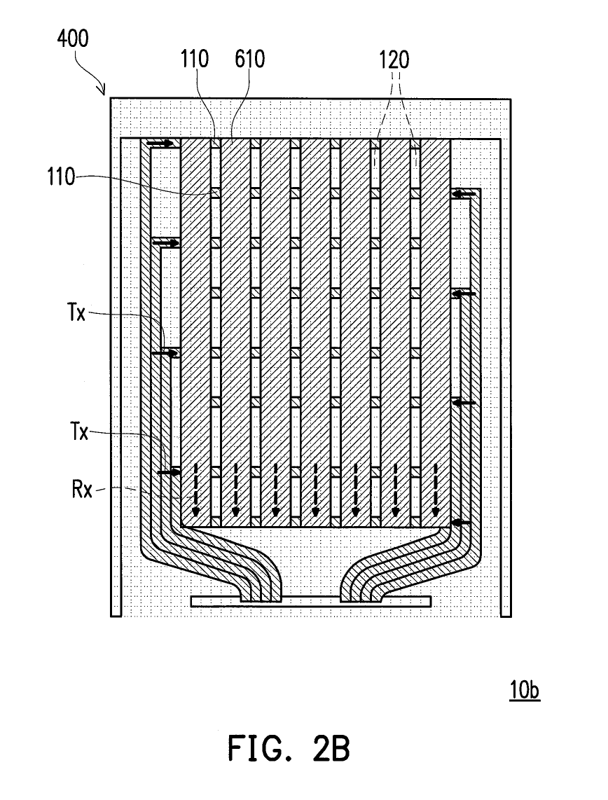

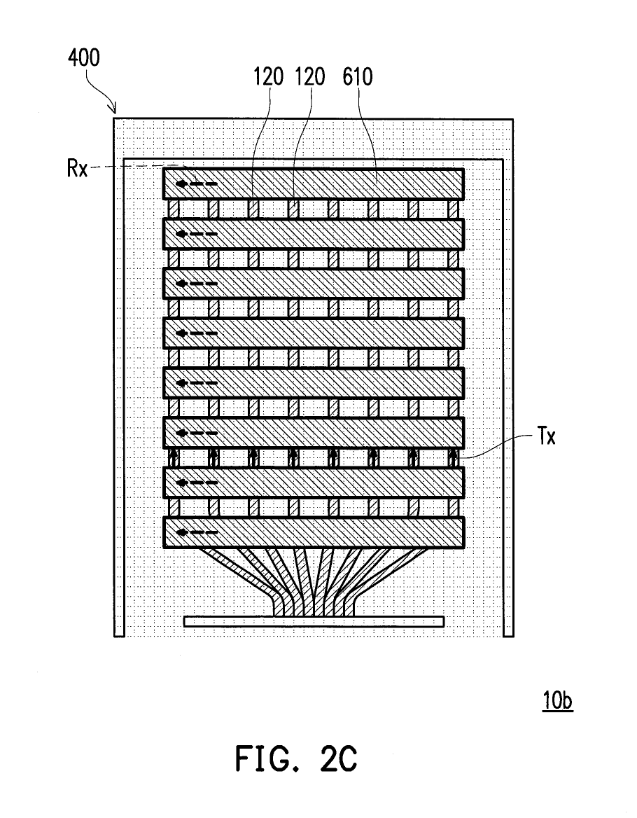

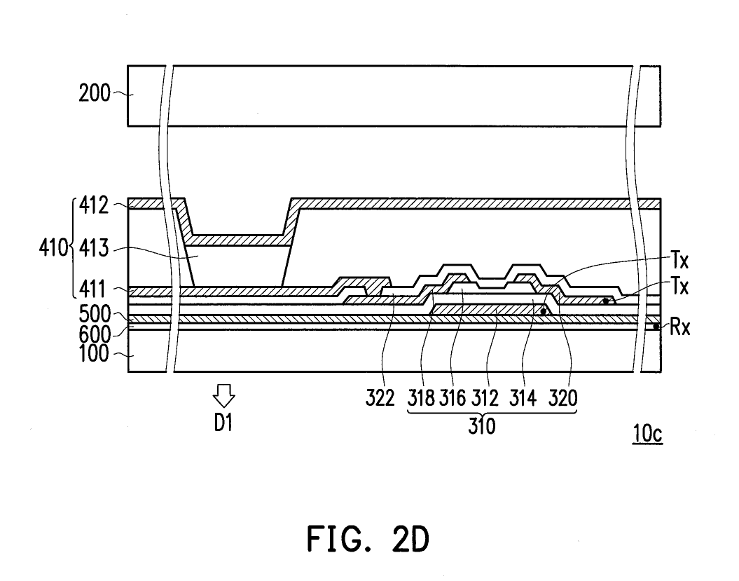

FIG. 2A is a schematic cross-sectional view of a touch display panel according to a second embodiment, and FIG. 2B and FIG. 2C are two schematic top views of the touch display panel according to the second embodiment. Referring to FIG. 2A, FIG. 2B and FIG. 2C, the touch display panel 10b of the present embodiment is similar to the touch display panel 10a of the previous embodiment, wherein a difference is that, in the touch display panel 10b shown in FIG. 2A, a transparent conductive layer 600 is additionally disposed on the first substrate 100. As shown in FIG. 2A, the transparent conductive layer 600 is disposed at a surface opposite to the active devices 310 and the organic light emitting diode pixel array 400, and the transparent conductive layer 600 includes a plurality of strip-shaped transparent conductive electrodes 610 for transmitting the touch sensing signal Rx. Now, one of the scan lines 110 and the data lines 120 may be utilized for transmitting the touch driving signal Tx; for example, FIG. 2B shows that the scan lines 110 are utilized for transmitting the touch driving signal Tx, while FIG. 2C shows that the data lines 120 are utilized for transmitting the touch driving signal Tx. The touch display panel 10b showing in FIG. 2B has data lines 120 disposed between and parallel to the strip-shaped transparent conductive electrodes 610, and the touch display panel 10b showing in FIG. 2C has scan lines (not shown) disposed under and parallel to the strip-shaped transparent conductive electrodes 610.

More specifically, in the present embodiment, the touch driving signal Tx is transmitted through the signal lines (the scan lines 110 or the data lines 120) on the first substrate 100 in a specific timing, and the touch sensing signal Rx is transmitted through the transparent conductive layer 600, which is comparatively closer to the touch display screen than the signal lines of transmitting the touch driving signal Tx. Descriptions regarding the scan lines 110 respectively transmitting the scanning signal and the touch driving signal Tx with different timings, and the data lines 120 respectively transmitting the data signal and the touch driving signal Tx with different timings, may be referred to the first embodiment, and thus are not repeated herein. Noteworthily, since touch sensing signal Rx in the touch display panel 10b of the present embodiment is transmitted through the transparent conductive electrodes 610 in the transparent conductive layer 600 instead of transmitting through the second electrodes 412 of the organic light emitting diode pixel units 410, it does not have to perform a switching during the time-sharing targeting the touch sensing signal Rx, thus designing a functionality of combining both a display device and a touch device.

Certainly, the transparent conductive layer 600 may also be, as shown in FIG. 2D, disposed between the first substrate 100 and the active devices 310, and now, by just disposing an insulating layer 500 between the transparent conductive layer 600 and the active devices 310, the scan lines 110 or the data lines 120 of transmitting the touch driving signal Tx is able to be disposed at the same side of the first substrate 100 as the transparent conductive layer 600 of transmitting the touch sensing signal Rx, thus achieving a thinning touch display panel 10c of integrating the touch function and the display function.

In addition, the pattern design of the scan lines 110 and data lines 120 utilized for transmitting the touch driving signal Tx according to the considerations of enhancing the sensor capacitance and the signal-to-noise ratio (SNR) and enhancing the overall induction capacity of the touch display panel 10b-10c may also be as shown in FIGS. 1D and 1E, and thus are repeated herein.

### Third Embodiment

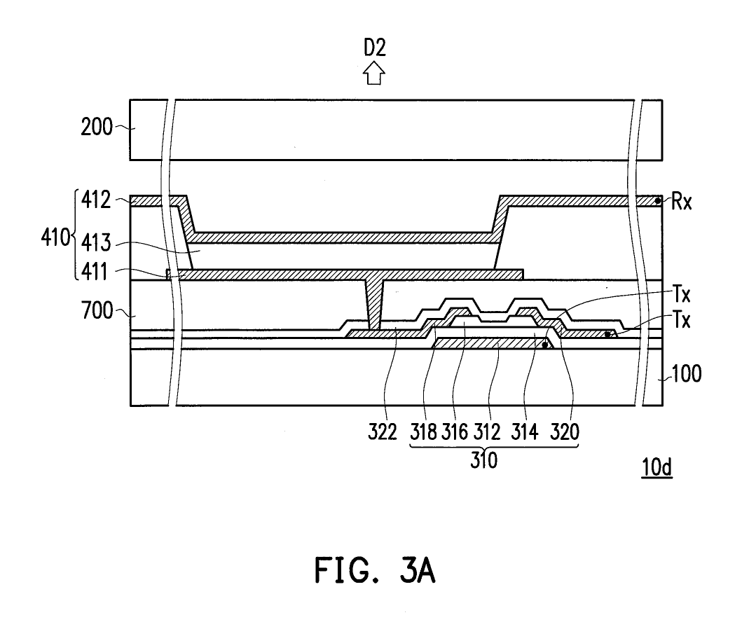

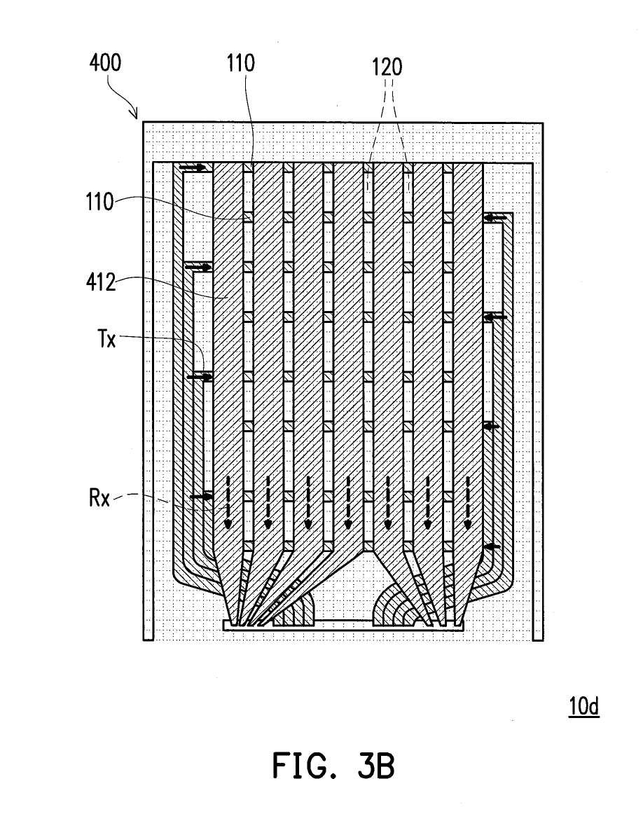

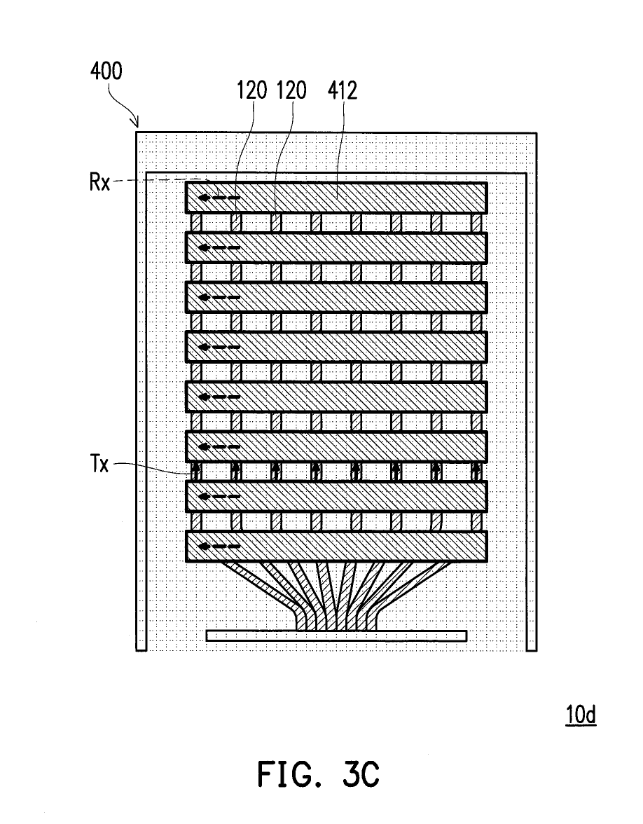

FIG. 3A is a schematic cross-sectional view of a touch display panel according to a third embodiment, and FIG. 3B and FIG. 3C are two schematic top views of the touch display panel according to the third embodiment. Referring to FIG. 3A, FIG. 3B and FIG. 3C, the touch display panel 10d of the present embodiment is similar to the touch display panel 10a of the previous embodiment, wherein a difference thereof is that, the touch display panel 10d of the present embodiment utilizes the second substrate 200 as the display screen, namely, the touch sensing signal Rx of the touch signal is able to combine onto the signal lines close to the second substrate 200 or the trace on the second substrate 200, and displays an organic emitted light towards a direction D2; therefore the touch display panel 10d of the present embodiment belongs to a top emission structure.

In addition, in the present embodiment, in order to enable the organic emitted light to uniformly emit out of the second substrate 200 to increase a strength of the organic emitted light, a planar layer 700 may be additionally disposed above between the active devices 310 and the first electrodes 411, so as to enable the first electrodes 411 to be planarized and expandedly produced on the first substrate 100. Particularly, in the organic light emitting diode pixel units 410 of the present embodiment, the touch sensing signal Rx is transmitted through the second electrodes 412, and the touch driving signal Tx is transmitted through either one of the plurality of the scan lines 110 and the plurality of the data lines 120; FIG. 3B shows that the scan lines 110 are utilized for transmitting the touch driving signal Tx, while FIG. 3C shows that the data lines 120 are utilized for transmitting the touch driving signal Tx.

More specifically, the present embodiment transmits the touch driving signal Tx through the signal lines (the scan lines 110 or the data lines 120) of the second substrate 200 away from the touch display screen in a specific timing, and transmit the touch sensing signal Rx through the second electrodes 412, which is comparatively closer to the touch display screen than the signal lines of transmitting the touch driving signal Tx. Descriptions regarding the scan lines 110 and the data lines 120 respectively transmitting the display signal and the touch driving signal Tx with different timings, and the second electrodes 412 respectively transmitting the common signal and the touch sensing signal Rx with different timings, may be referred to the previous embodiment, and thus is not repeated herein.

In addition, the pattern design and the design consideration of the scan lines 110 and data lines 120 may also be as described in the previous embodiment, and thus is not repeated herein.

### Fourth Embodiment

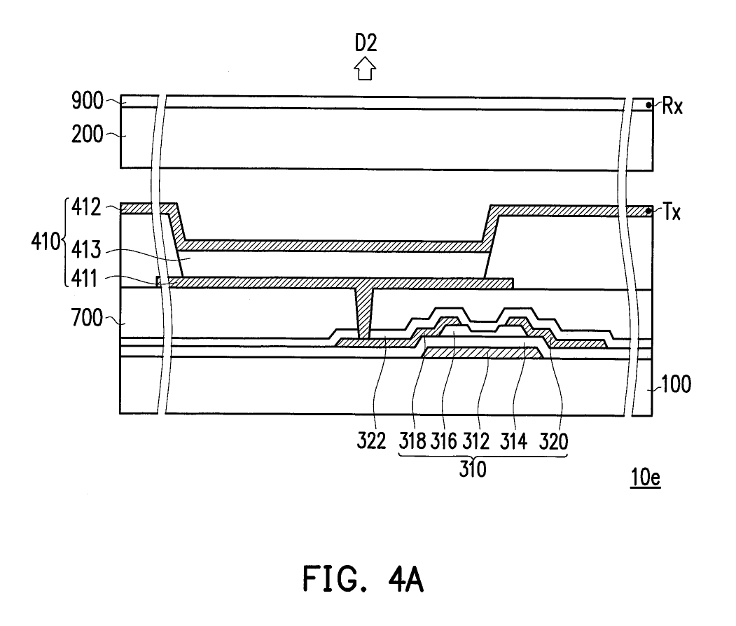

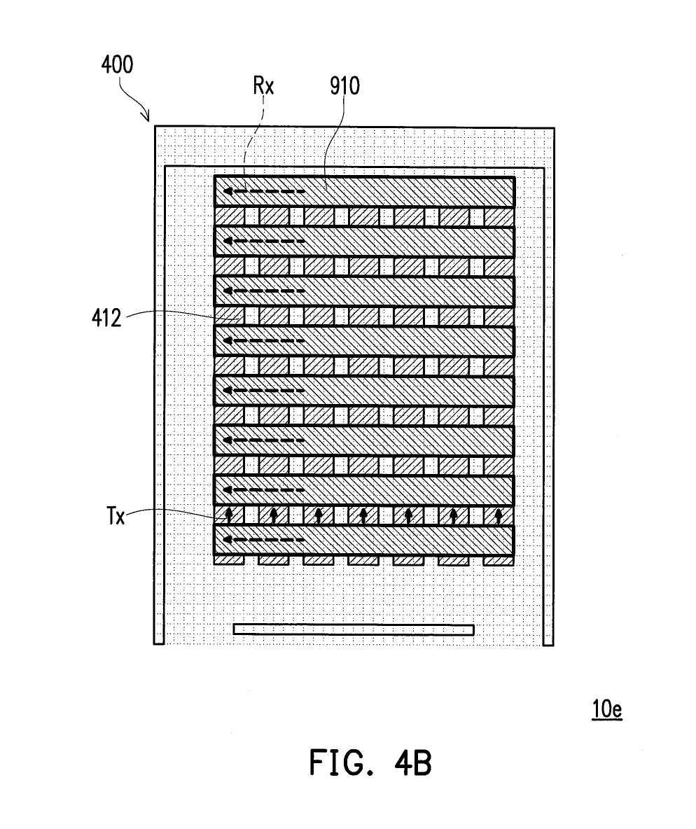

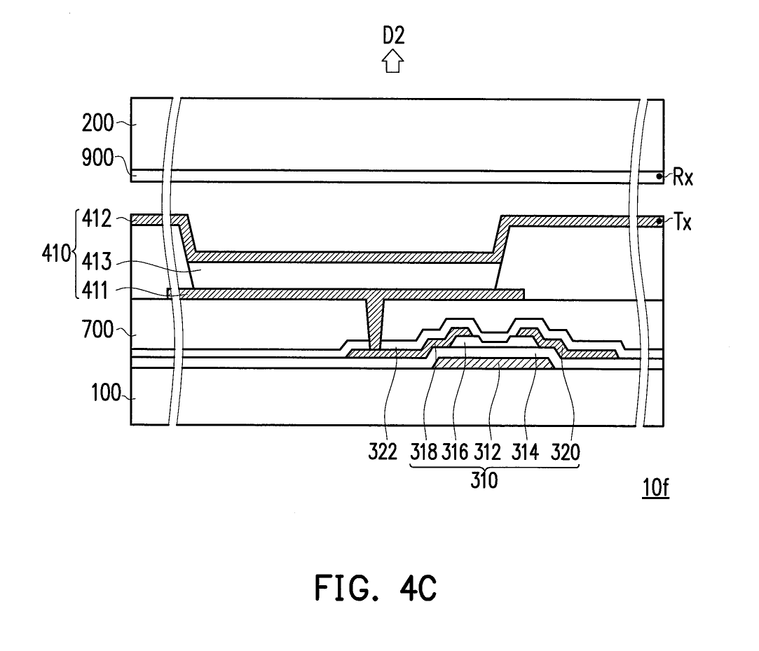

FIG. 4A is a schematic cross-sectional view of a touch display panel according to a fourth embodiment, and FIG. 4B is a schematic top view of the touch display panel according to the fourth embodiment. Referring to FIG. 4A and FIG. 4B, the touch display panel 10e of the present embodiment is similar to the display panel 10d of the third embodiment, wherein a difference thereof is that, in the touch display panel 10e shown in FIG. 4A, a transparent conductive layer 900 is additionally disposed on the second substrate 200. The transparent conductive layer 900 includes a plurality of strip-shaped transparent conductive electrodes 910 to transmit the touch sensing signal Rx. Now, the second electrodes 412 may be utilized for transmitting the touch driving signal Tx.

More specifically, in the present embodiment, the touch driving signal Tx is transmitted through the second electrodes 412 in a specific timing, and the touch sensing signal Rx is transmitted through the transparent conductive layer 900, which is comparatively closer to the touch display screen than the signal lines of transmitting the touch driving signal Tx. Descriptions regarding the second electrodes 412 respectively transmitting the common signal and the touch driving signal Tx with different timings may be referred to the first embodiment, and thus is not repeated herein. Noteworthily, the touch sensing signal Rx in the touch display panel 10e of the present embodiment is transmitted through a plurality of transparent conductive electrodes 910 in the transparent conductive layer 900, and does not have to perform the switching during the time-sharing targeting the touch sensing signal Rx, thus designing a functionality of combining both a display device and a touch device.

Certainly, the transparent conductive layer 900 may also be, as shown in FIG. 4C, disposed between the second substrate 200 and the second electrode 412 for disposing the transparent conductive layer 900 of transmitting the touch sensing signal Rx below the second substrate 200 and facing towards the second electrodes 412 of transmitting the touch driving signal on the first substrate 100, and achieving a thinning touch display panel 10f of integrating the touch function and the display function.

In addition, the pattern design and the design considerations of the scan lines 110 and the data lines 120 may also be as described in the previous embodiment, and thus is not repeated herein.

In summary, the touch display device constituting of the active devices and the organic light emitting diode pixel array utilizes at least one of the scan lines, the data lines and the second electrodes to transmit the touch driving signal or the touch sensing signal, and the display signal (the scanning signal, the data or the touch driving signal) are respectively transmitted with different timings. Hence, the touch display device of the invention is able to integrate the display component and the touch sensing components with only two substrates (100 and 200). Therefore, the touch display panel under a condition of not increasing the thickness thereof may have both features of the touch sensing function and the display function.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display panel, having a display screen, comprising:
a first substrate;
a plurality of scan lines and a plurality of data lines, disposed on the first substrate, wherein the scan lines and the data lines are intersected;
a plurality of active devices, disposed on the first substrate, wherein each active device is electrically connected with one of the corresponding scan lines and one of the corresponding data lines; and
an organic light emitting diode pixel array, disposed on the first substrate, wherein the organic light emitting diode pixel array comprises a plurality of organic light emitting diode pixel units, and each organic light emitting diode pixel unit comprises:
a first electrode, disposed on the first substrate and electrically connected with the corresponding active device;
a second electrode, disposed on the first substrate;
an organic light emitting layer, disposed on the first substrate, and the organic light emitting layer is disposed between the first electrode and the second electrode.
wherein, at least one of the plurality of scan lines, the plurality of data lines and the plurality of second electrodes transmits a touch driving signal or a touch sensing signal.

2. The touch display panel as recited in claim 1, further comprising;
a second substrate, being opposite to the first substrate, and the organic light emitting diode pixel array disposed between the first substrate and the second substrate; and
a transparent conductive layer disposed on the first substrate or the second substrate, wherein one of the plurality of scan lines, the plurality of data lines, the plurality of second electrodes and the transparent conductive layer close to the display screen transmits the touch sensing signal, and another one of the plurality of scan lines, the plurality of data lines, the plurality of second electrodes and the transparent conductive layer away from the display screen transmits the touch driving signal.

3. The touch display panel as recited in claim 1, wherein the display screen is the first substrate, one of the plurality of scan lines and the plurality of data lines transmits the touch driving signal or the touch sensing signal.

4. The touch display panel as recited in claim 3, wherein one of the plurality of scan lines and the plurality of data lines transmits the touch sensing signal, and the second electrodes transmit the touch driving signal.

5. The touch display panel as recited in claim 4, wherein the scan lines respectively transmit a scanning signal and the touch sensing signal with different timings, the data lines respectively transmit a data signal and the touch sensing signal with different timings, and the second electrodes respectively transmit a common signal and the touch driving signal with different timings.

6. The touch display panel as recited in claim 3, further comprising a transparent conductive layer disposed on the first substrate, and electrically insulated with the active devices, wherein the transparent conductive layer transmits the touch sensing signal, and one of the plurality of scan lines and the plurality of data lines transmits the touch driving signal.

7. The touch display panel as recited in claim 6, wherein the scan lines respectively transmit a scanning signal and the touch driving signal with different timings, or the data lines respectively transmit a data signal and the touch driving signal with different timings.

8. The touch display panel as recited in claim 6, wherein the first substrate is disposed between the active devices and the transparent conductive layer.

9. The touch display panel as recited in claim 6, further comprising an insulating layer disposed on the first substrate, wherein the insulating layer is disposed between the active devices and the transparent conductive layer.

10. The touch display panel as recited in claim 1, further comprising:
a second substrate, being opposite to the first substrate, wherein the display screen is the second substrate, the second electrodes transmit the touch driving signal or the touch sensing signal.

11. The touch display panel as recited in claim 10, wherein the second electrodes transmit the touch sensing signal, and one of the plurality of scan lines and the plurality of data lines transmits the touch driving signal.

12. The touch display panel as recited in claim 11, wherein the second electrodes respectively transmit a common signal and the touch sensing signal with different timings, the scan lines respectively transmit a scanning signal and the touch driving signal with different timings, and the data lines respectively transmit a data signal and the touch driving signal with different timings.

13. The touch display panel as recited in claim 10, further comprising a transparent conductive layer disposed on the second substrate, and electrically insulated with the second electrodes, wherein the transparent conductive layer transmits the touch sensing signal, and the second electrodes transmit the touch driving signal.

14. The touch display panel as recited in claim 13, wherein the second electrodes respectively transmit a common signal and the touch driving signal with different timings.

15. The touch display panel as recited in claim 13, wherein the second substrate is disposed between the second electrodes and the transparent conductive layer.

16. The touch display panel as recited in claim 13, wherein the transparent conductive layer is disposed at a surface of the second substrate that faces the second electrodes.
